(19) United States
(12) Patent Application Publication
(10) Pub. No.: US 2026/0287392 A1
(43) Pub. Date: Sep. 24, 2026

(54) Vibration Rectification Error Correction Circuit And Sensor Device

(71) Applicant: SEIKO EPSON CORPORATION, Tokyo (JP)

(72) Inventor: Ryoga MORI, Suwa (JP)

(21) Appl. No.: 19/401,922

(22) Filed: Nov. 26, 2025

(30) Foreign Application Priority Data
Nov. 28, 2024 (JP) 2024-207073

(51) Int. Cl. G01D 3/032; G01H 11/06; G01P 1/02; G01P 15/097; G01P 15/18

(52) U.S. Cl. CPC G01D 3/032; G01H 11/06; G01P 1/023; G01P 15/097; G01P 15/18

(57) ABSTRACT

A vibration rectification error correction circuit includes a signal processing unit configured to calculate a difference value between a first signal value based on a physical quantity detected by a first sensor having a first detection axis and a second signal value based on the physical quantity detected by a second sensor having a second detection axis in an opposite direction to the first detection axis, and a vibration rectification error of the difference value is smaller than a vibration rectification error of the first signal value and smaller than a vibration rectification error of the second signal value.

The present application is based on, and claims priority from JP Application Serial Number 2024-207073, filed Nov. 28, 2024, the disclosure of which is hereby incorporated by reference herein in its entirety.

### BACKGROUND

### 1. Technical Field

The present disclosure relates to a vibration rectification error correction circuit and a sensor device.

### 2. Related Art

JP-A-2019-191068 describes a vibration rectification error correction circuit that obtains a digital value based on a measured signal output from a sensor element and corrects a vibration rectification error of the digital value with a correction function based on a product of values obtained by biasing the digital value.

JP-A-2019-191068 is an example of the related art.

In a sensor device described in JP-A-2019-191068, it is necessary to determine a plurality of coefficient values of the correction function for the vibration rectification error and construct an arithmetic circuit according to the correction function.

### SUMMARY

A vibration rectification error correction circuit according to an aspect of the present disclosure includes a signal processing unit configured to calculate a difference value between a first signal value based on a physical quantity detected by a first sensor having a first detection axis and a second signal value based on the physical quantity detected by a second sensor having a second detection axis in an opposite direction to the first detection axis, and a vibration rectification error of the difference value is smaller than a vibration rectification error of the first signal value and smaller than a vibration rectification error of the second signal value.

A sensor device according to an aspect of the present disclosure includes: the vibration rectification error correction circuit according to the aspect; the first sensor; and the second sensor.

### BRIEF DESCRIPTION OF THE DRAWINGS

FIG. 1 is an external configuration diagram of a sensor device.

FIG. 2 is an exploded perspective view of the sensor device.

FIG. 3 is a schematic configuration diagram of the sensor device.

FIG. 4 is a schematic configuration diagram of the sensor device.

FIG. 5 is a schematic configuration diagram of a sensor.

FIG. 6 is a schematic configuration diagram of a sensor element.

FIG. 7 is a functional block diagram of the sensor device according to a first embodiment.

FIG. 8 illustrates an example of a relationship between a frequency of a sensor and an amplitude of acceleration in the first embodiment.

FIG. 9 illustrates an example of a relationship between a frequency of a sensor and an amplitude of acceleration in a second embodiment.

FIG. 10 illustrates another example of a relationship between a frequency of a sensor and an amplitude of acceleration in the second embodiment.

### DESCRIPTION OF EMBODIMENTS

Some preferred embodiments of the present disclosure will hereinafter be described in detail using the drawings. Note that the embodiments described below do not unreasonably limit the content of the present disclosure set forth in the appended claims. Not all of components explained below are always essential elements of the present disclosure.

### 1. First Embodiment

### 1-1. Structure of Sensor Device

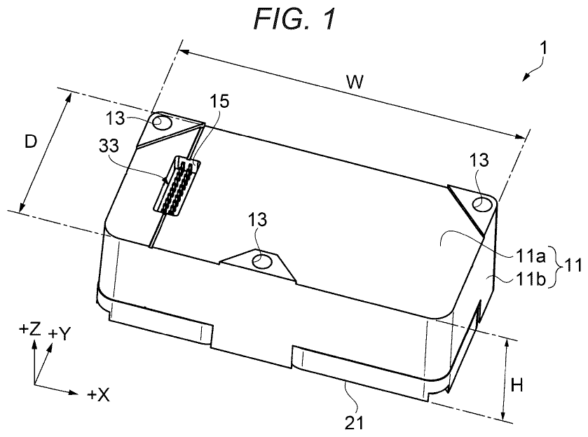

FIG. 1 is a diagram illustrating an external configuration of a sensor device 1. As illustrated in FIG. 1, the sensor device 1 has a rectangular parallelepiped shape with a width W, a depth D, and a height H. The width W is a length along a long side of the sensor device 1, the depth D is a length along a short side of the sensor device 1, and the height H is a length along a side perpendicular to the long side and the short side.

The sensor device 1 is a device that measures a physical quantity, and hereinafter, a device that measures acceleration as the physical quantity, specifically, a device that measures acceleration along three axes, namely, an X axis, a Y axis, and a Z axis, will be described as an example. The sensor device 1 may measure a physical quantity different from the acceleration.

As illustrated in FIG. 1, the X axis is an axis along the long side of the sensor device 1. In FIG. 1, a +X direction is a direction from left to right along the long side of the sensor device 1, and a −X direction is a direction from the right to the left along the long side of the sensor device 1. The Y axis is an axis along the short side of the sensor device 1. In FIG. 1, the +Y direction is a direction from front to back along the short side of the sensor device 1, and the −Y direction is a direction from the back to the front along the short side of the sensor device 1. The Z axis is an axis along a side perpendicular to the long side and the short side of the sensor device 1. In FIG. 1, a +Z direction is a direction from bottom to top of the sensor device 1, and a −Z direction is a direction from top to bottom of the sensor device 1.

As illustrated in FIG. 1, the sensor device 1 includes a container 11 and a lid portion 21. The container 11 accommodates a circuit board 31 described later. The container 11 is a box-shaped body having an opening in the −Z direction. The container 11 constitutes a part of an exterior housing of the sensor device 1 and is made of a metal material such as aluminum. The container 11 has a bottom portion 11a and a side portion 11b. The bottom portion 11a is formed in a flat plate shape, and is provided with three screw holes 13 and an opening 15. The side portion 11b is a frame-shaped member extending toward the −Z direction from an outer peripheral portion of the bottom portion 11a.

The three screw holes 13 are provided at two corners of the sensor device 1 and at a center of the long side. A fixing screw (not illustrated) is inserted into the screw hole 13. The sensor device 1 is fixed to a mounting target surface of a mounting target body by the fixing screw. The sensor device 1 is used while being directly or indirectly fixed to the mounting target surface of the mounting target body. The mounting target body is a structure such as a building, a bridge, or a machine. The structure may be a vehicle such as an automobile, a drone, a robot, or a ship.

A connector 33 described later is inserted into the opening 15. The connector 33 is provided at the circuit board 31 accommodated in the container 11.

The lid portion 21 is attached to a position of the container 11 in the −Z direction and covers the opening of the container 11 in the −Z direction. The lid portion 21 may be directly attached to the container 11, or may be attached via a seal member (not illustrated).

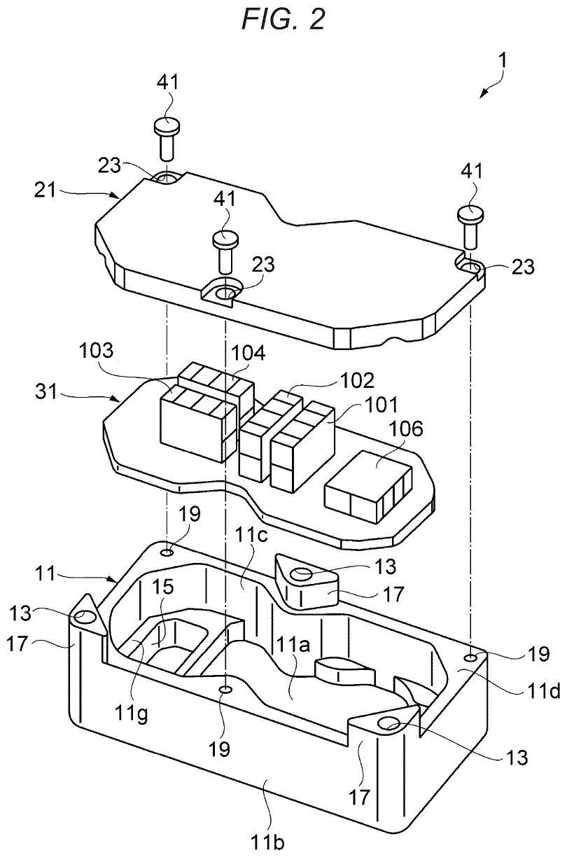

FIG. 2 is an exploded perspective view of the sensor device 1 and illustrates a state when the sensor device 1 is disassembled. The sensor device 1 is disassembled into the container 11, the lid portion 21, and the circuit board 31.

The container 11 has the bottom portion 11a having the opening 15, and the side portion 11b having an inner surface 11c and a support surface 11d. The inner surface 11c is an inner peripheral surface of the side portion 11b. The support surface 11d is an end surface of the side portion 11b in the −Z direction, faces the lid portion 21, and supports the lid portion 21.

As illustrated in FIG. 2, the support surface 11d of the container 11 is provided with three fixing protrusions 17 protruding from the support surface 11d in the −Z direction. The screw hole 13 is formed in each of the three fixing protrusions 17. In the support surface 11d of the container 11, three lid fixing screw holes 19 are provided at corners of the container 11 and at a center of the long side. A lid fixing screw 41 is inserted into the lid fixing screw hole 19.

Three through holes 23 are formed in the lid portion 21. The through holes 23 are formed at positions corresponding to the lid fixing screw holes 19 when the lid portion 21 is attached to the container 11. The lid fixing screw 41 is inserted into each of the three through holes 23. The lid portion 21 is attached to the container 11 with the lid fixing screws 41.

The circuit board 31 is accommodated in the container 11. The circuit board 31 is a multi-layer board in which a plurality of through holes and the like are formed. The circuit board 31 is formed of, for example, a glass epoxy substrate. The circuit board 31 may be formed of a composite board, a ceramic board, or the like.

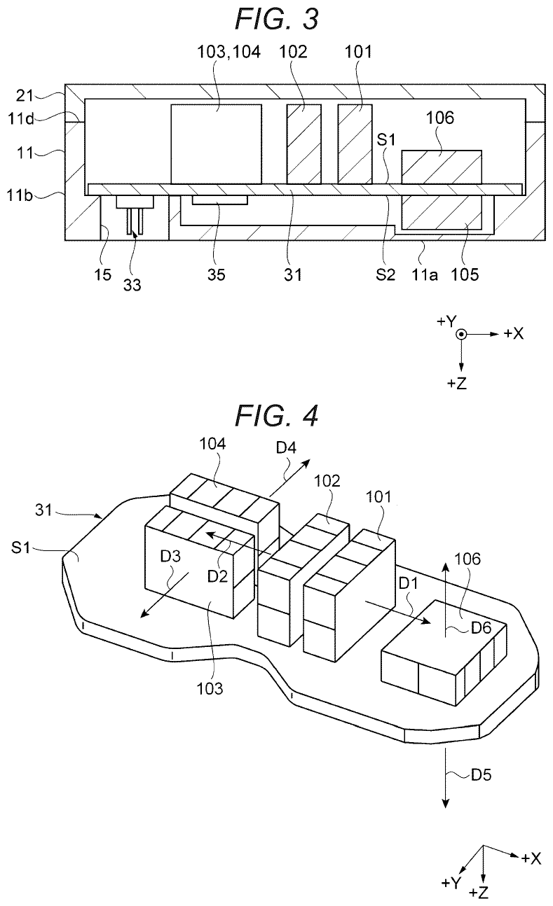

FIGS. 3 and 4 are diagrams illustrating a schematic configuration of the sensor device 1. FIG. 3 is an X—Z cross-sectional view of a substantially central portion of the sensor device 1 along the Y axis, and FIG. 4 is a perspective view of the circuit board 31.

As illustrated in FIGS. 3 and 4, the circuit board 31 has a first surface S1 and a second surface S2. The first surface S1 is a surface of the circuit board 31 in the −Z direction, and the second surface S2 is a surface of the circuit board 31 in the +Z direction. The circuit board 31 is in contact with the container 11 on the second surface S2 and is supported by the container 11.

Sensors 101, 102, 103, 104, 106 are placed on the first surface S1 of the circuit board 31. The connector 33, the processing circuit 35, and the sensor 105 are placed on the second surface S2 of the circuit board 31. Six amplifier circuits 301 to 306 (not illustrated) respectively coupled to the six sensors 101 to 106 are placed on the circuit board 31.

The six sensors 101 to 106 and the six amplifier circuits 301 to 306 constitute six oscillation circuits. The six oscillation signals output from the six oscillation circuits are input to the processing circuit 35, and the processing circuit 35 calculates data of the three-axis acceleration based on frequencies of the six oscillation signals.

The connector 33 is coupled to an external device, receives a drive voltage from the external device, and outputs various signals to the external device. The connector 33 is a plug having a plurality of pins, and the external device has a socket coupled to the plug. The sensors 101 to 106, the amplifier circuits 301 to 306, the processing circuit 35, and the connector 33 are electrically coupled via wiring (not illustrated).

The sensor 101 and the sensor 102 face each other. The sensor 103 and the sensor 104 face each other. The sensor 105 and the sensor 106 face each other via the circuit board 31.

The sensor 101 has a detection axis D1 in the +X direction and detects acceleration in the +X direction. The sensor 102 has a detection axis D2 in the −X direction and detects acceleration in the −X direction. The detection axis D2 is opposite to the detection axis D1.

The sensor 103 has a detection axis D3 in the +Y direction and detects acceleration in the +Y direction. The sensor 104 has a detection axis D4 in the −Y direction and detects acceleration in the −Y direction. The detection axis D4 is opposite to the detection axis D3.

The sensor 105 has a detection axis D5 in the +Z direction and detects acceleration in the +Z direction. The sensor 106 has a detection axis D6 in the −Z direction and detects acceleration in the −Z direction. The detection axis D6 is opposite to the detection axis D5.

### 1-2. Structure of Sensor

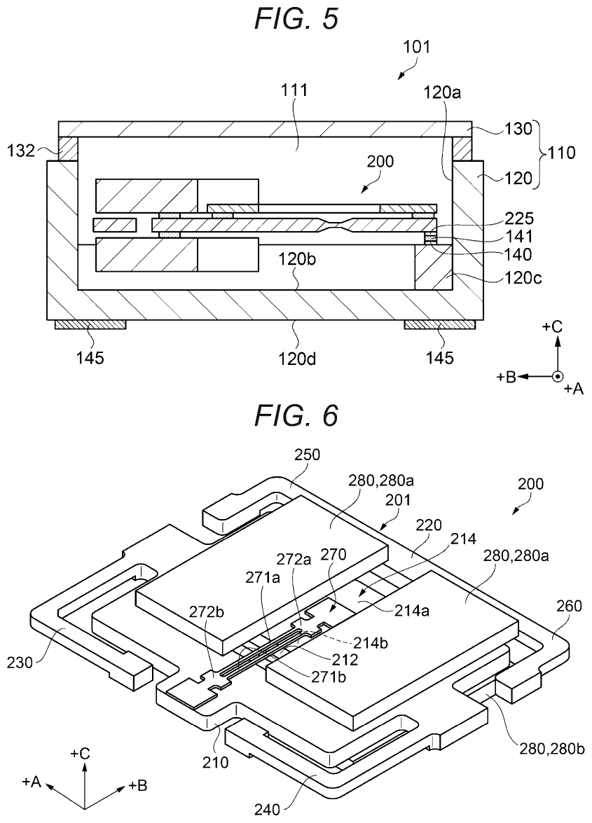

FIG. 5 is a diagram illustrating a schematic configuration of the sensor 101, and schematically illustrates a cross section of the sensor 101.

In FIG. 5, an A-axis and a B-axis are axes parallel to a plane of a flat plate-shaped substrate structure 201 described later, and the A-axis and the B-axis are perpendicular to each other. The A-axis is an axis perpendicular to a direction in which a vibration element 270 described later extends. A +A direction is a direction from the back to the front of the sensor 101, and a −A direction is a direction from the front to the back of the sensor 101. The B-axis is an axis parallel to the direction in which the vibration element 270 extends. A +B direction is a direction from the right to the left of the sensor 101, and a −B direction is a direction from the left to the right of the sensor 101. A C-axis is an axis perpendicular to the A-axis and the B-axis. A +C direction is a direction from bottom to top of the sensor 101, and a −C direction is a direction from the top to the bottom of the sensor 101.

The sensor 101 includes a sensor element 200 and a package 110, and accommodates the sensor element 200 in an accommodation space 111 formed by the package 110.

The package 110 is a housing defining the accommodation space 111, and includes a package base 120 and a lid 130. The accommodation space 111 is covered with the package base 120 and the lid 130.

The package base 120 is a box-shaped body having an opening in the +C direction, and has an inner side surface 120a, an inner bottom surface 120b, a step portion 120c, and an outer bottom surface 120d. The inner side surface 120a and the inner bottom surface 120b are surfaces inside the package base 120. The outer bottom surface 120d is an outer surface of the package base 120. The package base 120 includes an external terminal 145.

The step portion 120c is a portion protruding from the inner bottom surface 120b of the package base 120 in the +C direction, and is provided in a frame shape along the inner side surface 120a. The step portion 120c is provided with a plurality of internal terminals 140.

The plurality of internal terminals 140 are coupled to a fixing portion coupling terminal 225 provided in each of a first support portion 230, a second support portion 240, a third support portion 250, and a fourth support portion 260 of the sensor element 200, which will be described later. The internal terminal 140 and the fixing portion coupling terminal 225 are electrically and mechanically coupled via a conductive adhesive 141.

The external terminal 145 is provided on the outer bottom surface 120d and is electrically coupled to the internal terminal 140 via internal wiring (not illustrated). The external terminal 145 is electrically coupled to the sensor 101 via wiring provided at the circuit board 31. The external terminal 145 may be disposed on an outer surface of the package base 120 different from the outer bottom surface 120d.

The lid 130 is a flat plate-shaped member and closes the opening of the package base 120. The lid 130 is attached to the package base 120 via a lid bonding member 132. By the lid 130 closing the opening of the package base 120, the accommodation space 111 in which the sensor element 200 is accommodated is airtightly sealed.

FIG. 6 illustrates a schematic configuration of the sensor element 200. FIG. 6 is a perspective view illustrating the sensor element 200. The sensor element 200 includes the substrate structure 201, the vibration element 270, and mass portions 280.

The substrate structure 201 has a flat plate shape having a main surface parallel to an A-B plane, and includes a base portion 210, a movable portion 214, a coupling portion 220, the first support portion 230, the second support portion 240, the third support portion 250, and the fourth support portion 260. The substrate structure 201 is formed of, for example, a quartz crystal substrate. The substrate structure 201 may be made of a material other than quartz crystal.

The base portion 210 is coupled to the movable portion 214 via a groove-shaped joint portion 212 along the A-axis, and swingably supports the movable portion 214. The base portion 210 has a U-shape bending at a right angle in a plan view from the +C direction. The coupling portion 220 couples both ends of the U-shape formed by the base portion 210 along the A-axis in the +B direction of the movable portion 214. Accordingly, the base portion 210 and the coupling portion 220 each have a schematic frame shape in the plan view. The first support portion 230 and the second support portion 240 are coupled to the base portion 210 in the +A direction and the −A direction. The third support portion 250 and the fourth support portion 260 are coupled to the base portion 210 near the coupling portion 220.

The joint portion 212 is provided between the base portion 210 and the movable portion 214 and couples the base portion 210 and the movable portion 214. A thickness of the joint portion 212 along the C-axis is smaller than a thickness of the base portion 210 along the C-axis and a thickness of the movable portion 214 along the C-axis. The joint portion 212 is formed in a constricted shape on both sides along the C-axis in the plan view from the +A direction, and functions as a fulcrum when the movable portion 214 is displaced with respect to the base portion 210.

The movable portion 214 is coupled to the base portion 210 via the joint portion 212. The movable portion 214 has a flat plate shape and has a first main surface 214a and a second main surface 214b. The first main surface 214a is a surface of the movable portion 214 in the +C direction, and the second main surface 214b is a surface of the movable portion 214 in the −C direction. The first main surface 214a and the second main surface 214b have a front-back relationship. The movable portion 214 is displaced along the C-axis with the joint portion 212 as a fulcrum in accordance with acceleration along the C-axis. That is, the joint portion 212 and the movable portion 214 function as cantilevers that are deformed by application of acceleration along the C-axis.

The first support portion 230 has an arm shape bent at a right angle along the A-axis and the B-axis, and is disposed at a position of the sensor element 200 in the +A direction and the −B direction. The second support portion 240 has an arm shape bent at a right angle along the A-axis and the B-axis, and is disposed at a position of the sensor element 200 in the −A direction and the −B direction. The first support portion 230 and the second support portion 240 are disposed symmetrically about a center line of the vibration element 270 along the B-axis in the plan view from the +C direction.

The third support portion 250 has an arm shape bent at a right angle along the A-axis and the B-axis, and is disposed at a position of the sensor element 200 in the +A direction and the +B direction. The fourth support portion 260 has an arm shape bent at a right angle along the A-axis and the B-axis, and is disposed at a position of the sensor element 200 in the −A direction and the +B direction. The third support portion 250 and the fourth support portion 260 are disposed symmetrically about the center line of the vibration element 270 along the B-axis in the plan view from the +C direction.

Distal end portions of the first support portion 230, the second support portion 240, the third support portion 250, and the fourth support portion 260 are coupled to the step portion 120c of the package 110. The first support portion 230, the second support portion 240, the third support portion 250, and the fourth support portion 260 support the base portion 210 in the accommodation space 111.

Both ends of the vibration element 270 along the B-axis are coupled to the base portion 210 and the movable portion 214 of the substrate structure 201. The vibration element 270 is provided at the base portion 210 and the movable portion 214 across the joint portion 212.

The vibration element 270 is formed of, for example, a quartz crystal substrate. The vibration element 270 may be formed of a piezoelectric material other than quartz crystal. The vibration element 270 and the substrate structure 201 are preferably formed of the same material. When the vibration element 270 and the substrate structure 201 are formed of the same material, a difference between a linear expansion coefficient of the substrate structure 201 and a linear expansion coefficient of the vibration element 270 is reduced, and it is possible to reduce stress applied from the substrate structure 201 to the vibration element 270 due to the difference in the linear expansion coefficient.

The vibration element 270 is, for example, a double-ended tuning fork type vibration element. The vibration element 270 includes a first vibration beam portion 271a, a second vibration beam portion 271b, a first element base portion 272a, and a second element base portion 272b. The first vibration beam portion 271a and the second vibration beam portion 271b extend along the B-axis. The first element base portion 272a is coupled to end portions of the first vibration beam portion 271a and the second vibration beam portion 271b in the +B direction. The first element base portion 272a is coupled to the movable portion 214. The second element base portion 272b is coupled to end portions of the first vibration beam portion 271a and the second vibration beam portion 271b in the −B direction. The second element base portion 272b is coupled to the base portion 210 of the substrate structure 201. The vibration element 270 is not limited to the double-ended tuning fork type vibration element, and may be, for example, a single beam type vibration element having one vibration beam portion.

The vibration element 270 includes excitation electrodes (not illustrated) provided at a surface thereof. When a drive signal of an AC voltage is applied to the excitation electrode provided at the vibration element 270, the first vibration beam portion 271a and the second vibration beam portion 271b perform a flexural vibration of getting away from each other and coming closer to each other along the A-axis. That is, the vibration element 270 functions as a resonator.

The sensor element 200 includes a plurality of mass portions 280. Out of the plurality of mass portions 280, first mass portions 280a are disposed at the first main surface 214a of the movable portion 214. Two first mass portions 280a are disposed at the first main surface 214a. The first mass portions 280a are bonded to the first main surface 214a via a bonding material (not illustrated). Out of the plurality of mass portions 280, second mass portions 280b are disposed at the second main surface 214b of the movable portion 214. Two second mass portions 280b are disposed at the second main surface 214b. The second mass portions 280b are bonded to the second main surface 214b via a bonding material (not illustrated). The mass portions 280 are made of a metal such as copper or gold. The number of mass portions 280 may be one.

When acceleration in the +C direction is applied to the sensor element 200, the movable portion 214 is displaced in the −C direction with the joint portion 212 as a fulcrum. When the movable portion 214 is displaced in the −C direction, forces in directions away from each other along the B-axis are applied to the first element base portion 272a and the second element base portion 272b, and tensile stress occurs in the first vibration beam portion 271a and the second vibration beam portion 271b. Due to the tensile stress, a resonance frequency of the first vibration beam portion 271a and the second vibration beam portion 271b increases.

When acceleration in the −C direction is applied to the sensor element 200, the movable portion 214 is displaced in the +C direction with the joint portion 212 as a fulcrum. When the movable portion 214 is displaced in the +C direction, forces in directions approaching each other along the B-axis are applied to the first element base portion 272a and the second element base portion 272b, and compressive stress occurs in the first vibration beam portion 271a and the second vibration beam portion 271b. Due to the compressive stress, a resonance frequency of the first vibration beam portion 271a and the second vibration beam portion 271b decrease.

The sensor element 200 can detect acceleration in the +C direction and the −C direction based on the resonance frequency of the vibration element 270. When the acceleration in the +C direction is positive acceleration, the acceleration in the −C direction corresponds to negative acceleration in the +C direction, and thus it can be said that the sensor element 200 detects the positive acceleration and the negative acceleration in the +C direction. That is, the sensor element 200 is a frequency change type acceleration sensor element that has a detection axis in the +C direction and detects acceleration in the +C direction.

In the sensor element 200 provided in the sensor 101, when the drive signal is applied to an electrode via the external terminal 145, the internal terminal 140, the fixing portion coupling terminal 225, and the like, the first vibration beam portion 271a and the second vibration beam portion 271b resonate at a predetermined frequency. The sensor 101 outputs, as an output signal, a resonance frequency of the sensor element 200 that changes in accordance with the acceleration. That is, the sensor 101 is a frequency change type acceleration sensor in which the detection axis is the C-axis.

Since structures of the sensors 102 to 106 are the same as that of the sensor 101, illustration and description thereof will be omitted. The sensor 101 is disposed so that the detection axis in the +C direction is along the +X direction, thereby detecting acceleration in the +X direction. The sensor 102 is disposed so that the detection axis in the +C direction is along the −X direction, thereby detecting acceleration in the −X direction. The sensor 103 is disposed so that the detection axis in the +C direction is along the +Y direction, thereby detecting acceleration in the +Y direction. The sensor 104 is disposed so that the detection axis in the +C direction is along the −Y direction, thereby detecting acceleration in the −Y direction. The sensor 105 is disposed so that the detection axis in the +C direction is along the +Z direction, thereby detecting acceleration in the +Z direction. The sensor 106 is disposed so that the detection axis in the +C direction is along the −Z direction, thereby detecting acceleration in the −Z direction.

### 1-3. Functional Configuration of Sensor Device

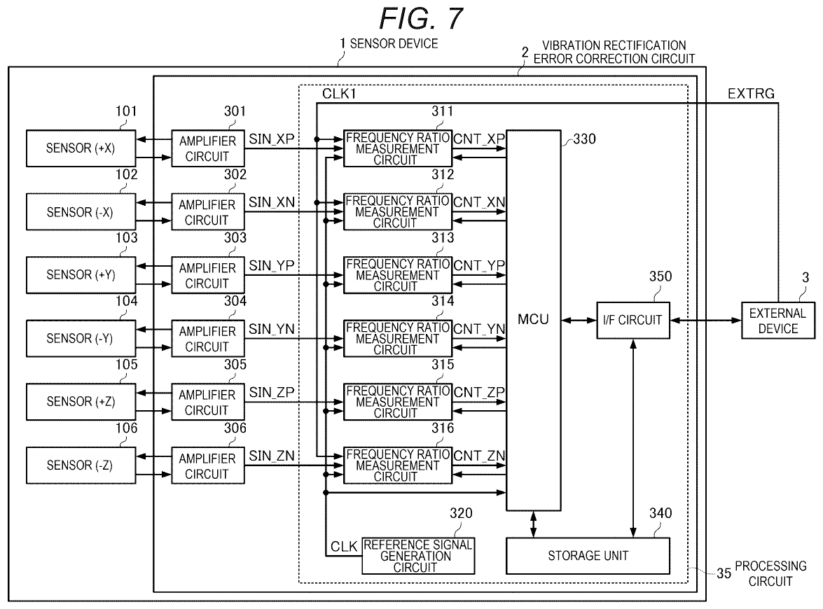

FIG. 7 is a functional block diagram of the sensor device 1 according to the first embodiment. As described above, the sensor device 1 includes the sensors 101 to 106 described above and a vibration rectification error correction circuit 2.

As described above, the sensor 101 has the detection axis D1 and detects the acceleration in the +X direction. The sensor 102 has the detection axis D2 in an opposite direction to the detection axis D1, and detects the acceleration in the −X direction. The sensor 103 has the detection axis D3 and detects the acceleration in the +Y direction. The sensor 104 has the detection axis D4 in an opposite direction to the detection axis D3, and detects the acceleration in the −Y direction. The sensor 105 has the detection axis D5 and detects the acceleration in the +Z direction. The sensor 106 has the detection axis D6 in an opposite direction to the detection axis D5, and detects the acceleration in the −Z direction.

The vibration rectification error correction circuit 2 includes the amplifier circuits 301 to 306 described above and the processing circuit 35 described above.

The amplifier circuit 301 amplifies an output signal of the sensor 101 to generate a drive signal, and applies the drive signal to the sensor 101. The drive signal causes the vibration element 270 of the sensor 101 to vibrate at a frequency corresponding to the acceleration in the +X direction, and a signal having the frequency is output from the sensor 101. The amplifier circuit 301 outputs a measured signal SIN_XP, which is a rectangular wave signal obtained by amplifying the output signal of the sensor 101, to a frequency ratio measurement circuit 311.

The amplifier circuit 302 amplifies an output signal of the sensor 102 to generate a drive signal, and applies the drive signal to the sensor 102. The drive signal causes the vibration element 270 of the sensor 102 to vibrate at a frequency corresponding to the acceleration in the −X direction, and a signal having the frequency is output from the sensor 102. The amplifier circuit 302 outputs a measured signal SIN_XN, which is a rectangular wave signal obtained by amplifying the output signal of the sensor 102, to a frequency ratio measurement circuit 312.

The amplifier circuit 303 amplifies an output signal of the sensor 103 to generate a drive signal, and applies the drive signal to the sensor 103. The drive signal causes the vibration element 270 of the sensor 103 to vibrate at a frequency corresponding to the acceleration in the +Y direction, and a signal having the frequency is output from the sensor 103. The amplifier circuit 303 outputs a measured signal SIN_YP, which is a rectangular wave signal obtained by amplifying the output signal of the sensor 103, to a frequency ratio measurement circuit 313.

The amplifier circuit 304 amplifies an output signal of the sensor 104 to generate a drive signal, and applies the drive signal to the sensor 104. The drive signal causes the vibration element 270 of the sensor 104 to vibrate at a frequency corresponding to the acceleration in the −Y direction, and a signal having the frequency is output from the sensor 104. The amplifier circuit 304 outputs a measured signal SIN_YN, which is a rectangular wave signal obtained by amplifying the output signal of the sensor 104, to a frequency ratio measurement circuit 314.

The amplifier circuit 305 amplifies an output signal of the sensor 105 to generate a drive signal, and applies the drive signal to the sensor 105. The drive signal causes the vibration element 270 of the sensor 105 to vibrate at a frequency corresponding to the acceleration in the +Z direction, and a signal having the frequency is output from the sensor 105. The amplifier circuit 305 outputs a measured signal SIN_ZP, which is a rectangular wave signal obtained by amplifying the output signal of the sensor 105, to a frequency ratio measurement circuit 315.

The amplifier circuit 306 amplifies an output signal of the sensor 106 to generate a drive signal, and applies the drive signal to the sensor 106. The drive signal causes the vibration element 270 of the sensor 106 to vibrate at a frequency corresponding to the acceleration in the −Z direction, and a signal having the frequency is output from the sensor 106. The amplifier circuit 306 outputs a measured signal SIN_ZN, which is a rectangular wave signal obtained by amplifying the output signal of the sensor 106, to a frequency ratio measurement circuit 316.

The processing circuit 35 includes the frequency ratio measurement circuits 311 to 316, a reference signal generation circuit 320, a micro control unit 330, a storage unit 340, and an interface circuit 350.

The reference signal generation circuit 320 generates and outputs a reference signal CLK having a constant frequency. The reference signal CLK preferably has high frequency accuracy, and the reference signal generation circuit 320 may be, for example, a temperature compensated crystal oscillator.

The frequency ratio measurement circuit 311 counts the number of pulses of the reference signal CLK in a predetermined period of the measured signal SIN_XP output from the amplifier circuit 301, and outputs a count value CNT_XP. The count value CNT_XP is a count value corresponding to a frequency ratio between the measured signal SIN_XP and the reference signal CLK.

The frequency ratio measurement circuit 312 counts the number of pulses of the reference signal CLK in a predetermined period of the measured signal SIN_XN output from the amplifier circuit 302, and outputs a count value CNT_XN. The count value CNT_XN is a count value corresponding to a frequency ratio between the measured signal SIN_XN and the reference signal CLK.

The frequency ratio measurement circuit 313 counts the number of pulses of the reference signal CLK in a predetermined period of the measured signal SIN_YP output from the amplifier circuit 303, and outputs a count value CNT YP. The count value CNT YP is a count value corresponding to a frequency ratio between the measured signal SIN_YP and the reference signal CLK.

The frequency ratio measurement circuit 314 counts the number of pulses of the reference signal CLK in a predetermined period of the measured signal SIN_YN output from the amplifier circuit 304, and outputs a count value CNT_YN. The count value CNT_YN is a count value corresponding to a frequency ratio between the measured signal SIN_YN and the reference signal CLK.

The frequency ratio measurement circuit 315 counts the number of pulses of the reference signal CLK in a predetermined period of the measured signal SIN_ZP output from the amplifier circuit 305, and outputs a count value CNT_ZP. The count value CNT_ZP is a count value corresponding to a frequency ratio between the measured signal SIN_ZP and the reference signal CLK.

The frequency ratio measurement circuit 316 counts the number of pulses of the reference signal CLK in a predetermined period of the measured signal SIN_ZN output from the amplifier circuit 306, and outputs a count value CNT_ZN. The count value CNT_ZN is a count value corresponding to a frequency ratio between the measured signal SIN_ZN and the reference signal CLK.

The storage unit 340 stores programs and data, and may include a volatile memory such as an SRAM or a DRAM. The SRAM is an abbreviation for Static Random Access Memory, and the DRAM is an abbreviation for Dynamic Random Access Memory. The storage unit 340 may include a nonvolatile memory such as a semiconductor memory such as an EEPROM or a flash memory, a magnetic storage device such as a hard disk device, or an optical storage device such as an optical disk device. The EEPROM is an abbreviation for Electrically Erasable Programmable Read Only Memory.

The micro control unit 330 operates in synchronization with the reference signal CLK and executes a program (not illustrated) stored in the storage unit 340 to perform predetermined arithmetic processing and control processing. For example, the micro control unit 330 measures X-axis acceleration based on the count value CNT_XP output from the frequency ratio measurement circuit 311 and the count value CNT_XN output from the frequency ratio measurement circuit 312. The micro control unit 330 measures Y-axis acceleration based on the count value CNT YP output from the frequency ratio measurement circuit 313 and the count value CNT_YN output from the frequency ratio measurement circuit 314. The micro control unit 330 measures Z-axis acceleration based on the count value CNT_ZP output from the frequency ratio measurement circuit 315 and the count value CNT_ZN output from the frequency ratio measurement circuit 316.

Specifically, the micro control unit 330 converts the count values CNT_XP and CNT_XN into an acceleration value in the +X direction and an acceleration value in the −X direction, respectively. The acceleration value in the +X direction is a signal value based on the acceleration detected by the sensor 101, and the acceleration value in the −X direction is a signal value based on the acceleration detected by the sensor 102. The micro control unit 330 calculates a difference value between the acceleration value in the +X direction and the acceleration value in the −X direction as an X-axis acceleration value.

Similarly, the micro control unit 330 converts the count values CNT YP and CNT_YN into an acceleration value in the +Y direction and an acceleration value in the −Y direction, respectively. The acceleration value in the +Y direction is a signal value based on the acceleration detected by the sensor 103, and the acceleration value in the −Y direction is a signal value based on the acceleration detected by the sensor 104. The micro control unit 330 calculates a difference value between the acceleration value in the +Y direction and the acceleration value in the −Y direction as a Y-axis acceleration value.

Similarly, the micro control unit 330 converts the count values CNT_ZP and CNT_ZN into an acceleration value in the +Z direction and an acceleration value in the −Z direction, respectively. The acceleration value in the +Z direction is a signal value based on the acceleration detected by the sensor 105, and the acceleration value in the −Z direction is a signal value based on the acceleration detected by the sensor 106. The micro control unit 330 calculates a difference value between the acceleration value in the +Z direction and the acceleration value in the −Z direction as a Z-axis acceleration value.

For example, the storage unit 340 may store table information defining a correspondence relationship between the count value and the acceleration value or information on a relational expression between the count value and the acceleration value, and the micro control unit 330 may refer to the information to convert the count value into the acceleration value.

The micro control unit 330 may generate measurement data including the calculated X-axis acceleration value, Y-axis acceleration value, and Z-axis acceleration value, and transmit the measurement data to an external device 3 via the interface circuit 350. Alternatively, the micro control unit 330 may write the measurement data to the storage unit 340, and the external device 3 may read the measurement data via the interface circuit 350.

### 1-4. Vibration Rectification Error Correction

The output signal of the sensor 101 has a frequency Y₁ that changes according to a magnitude of the acceleration in the +X direction. When sensitivity nonlinearity of the sensor 101 is considered up to a second-order coefficient, a relationship between an input acceleration X in the +X direction and the frequency Y₁ is represented by formula (1). In the formula (1), Y_{1(0G)} is a frequency when the acceleration X is 0 G, A₁ is a second-order sensitivity coefficient, and B₁ is a first-order sensitivity coefficient.

$${Y}_{1} = {Y}_{1 ( 0 G )} + {A}_{1} \cdot {X}^{2} + {B}_{1} \cdot X \qquad ( 1 )$$

A quadratic term in the formula (1) causes non-linearity of the output frequency Y₁ relative to the acceleration X, and this non-linearity causes a vibration rectification error (VRE).

The vibration rectification error is calculated as follows. When the acceleration X=X₁·cos(ωt), which is sinusoidal vibration, is input, the frequency Y₁ is represented by formula (2) from the formula (1).

$${Y}_{1} = {Y}_{1 ( 0 G )} + {A}_{1} \cdot {( {X}_{1} \cdot cos ( ω t ) )}^{2} + {B}_{1} \cdot {X}_{1} \cdot cos ( ω t ) \qquad ( 2 )$$

From the formula (2), a time average value Y_{1.AVE} of the acceleration in a time T (2Nπ/ω) of N periods from a time 0 is represented by formula (3).

$${Y}_{1. AVE} = \frac{{\int }_{0}^{T} {Y}_{1 ( 0 G )} \cdot dt + {A}_{1} \cdot {{X}_{1}}^{2} {\int }_{0}^{T} {cos ( ω t )}^{2} \cdot dt + {\int }_{0}^{T} cos ( ω t ) \cdot dt}{T} = \frac{{\int }_{0}^{T} {Y}_{1 ( 0 G )} \cdot dt + {A}_{1} \cdot {{X}_{1}}^{2} {\int }_{0}^{T} \frac{1 + cos ( 2 ω t )}{2} \cdot dt + {\int }_{0}^{T} cos ( ω t ) \cdot dt}{T} \qquad ( 3 )$$

When cos(ωt) is integrated over the N periods, cos(ωt)≈0 is obtained, and thus formula (4) is obtained from the formula (3).

$${Y}_{1. AVE} = {Y}_{1 ( 0 G )} + \frac{{A}_{1} \cdot {{X}_{1}}^{2}}{2} + 0 \qquad ( 4 )$$

Therefore, a vibration rectification error VRE₁ of the acceleration value in the +X direction is represented by formula (5).

$${VRE}_{1} = {Y}_{1. AVE} - {Y}_{1 ( 0 G )} = \frac{{A}_{1} \cdot {{X}_{1}}^{2}}{2} \qquad ( 5 )$$

Since the sensor 102 is mounted in a direction facing the sensor 101 and a frequency Y₂ changes according to a magnitude of the acceleration in the −X direction, positive and negative of the input acceleration X are reversed in the sensor 101 and the sensor 102. Therefore, a relationship between an acceleration −X=−X₁·cos(ωt) in the −X direction input to the sensor 102 and the frequency Y₂ is represented by formula (6). In the formula (6), Y_{2(0G)} is a frequency when the acceleration −X is 0 G, A₂ is a second-order sensitivity coefficient, and B₂ is a first-order sensitivity coefficient.

$${Y}_{2} = {Y}_{2 ( 0 G )} + {A}_{2} \cdot {( - {X}_{1} \cdot cos ( ω t ) )}^{2} + {B}_{2} \cdot - {X}_{1} \cdot cos ( ω t ) = {Y}_{2 ( 0 G )} + {A}_{2} \cdot {( {X}_{1} \cdot cos ( ω t ) )}^{2} - {B}_{2} \cdot {X}_{1} \cdot cos ( ω t ) \qquad ( 6 )$$

Therefore, a vibration rectification error VRE₂ of the acceleration value in the −X direction is represented by formula (7).

$${VRE}_{2} = \frac{{A}_{2} \cdot {{X}_{1}}^{2}}{2} \qquad ( 7 )$$

Regarding this, from the formulas (2) and (6), a frequency Y₁₋₂ obtained by subtracting the frequency Y₂ from the frequency Y₁ is represented by formula (8).

$${Y}_{1 - 2} = {Y}_{1} - {Y}_{2} = ( {Y}_{1 ( 0 G )} + {A}_{1} \cdot {( {X}_{1} \cdot cos ( ω t ) )}^{2} + {B}_{1} \cdot {X}_{1} \cdot cos ( ω t ) ) - {Y}_{2 ( 0 G )} + {A}_{2} \cdot {( {X}_{1} \cdot cos ( ω t ) )}^{2} + {B}_{2} \cdot - {X}_{1} \cdot cos ( ω t ) ) = {Y}_{1 ( 0 G )} - {Y}_{2 ( 0 G )} + ( {A}_{1} - {A}_{2} ) \cdot {( {X}_{1} \cdot cos ( ω t ) )}^{2} + ( {B}_{1} + {B}_{2} ) \cdot {X}_{1} \cdot cos ( ω t ) \qquad ( 8 )$$

As described above, each of the sensors 101, 102 has a structure in which the cantilever is deformed by application of the acceleration and a frequency at which the vibration element 270 vibrates is changed by stress caused by the deformation of the cantilever, an individual difference in a second-order coefficient of sensitivity is reduced due to an integrated structure with the cantilever, and the vibration element 270 is the quartz crystal vibration element having high frequency stability, and thus a difference in the second-order coefficients A₁, A₂ is very small. Therefore, the second-order coefficient (A₁-A₂) of the frequency Y₁₋₂ becomes a value close to 0.

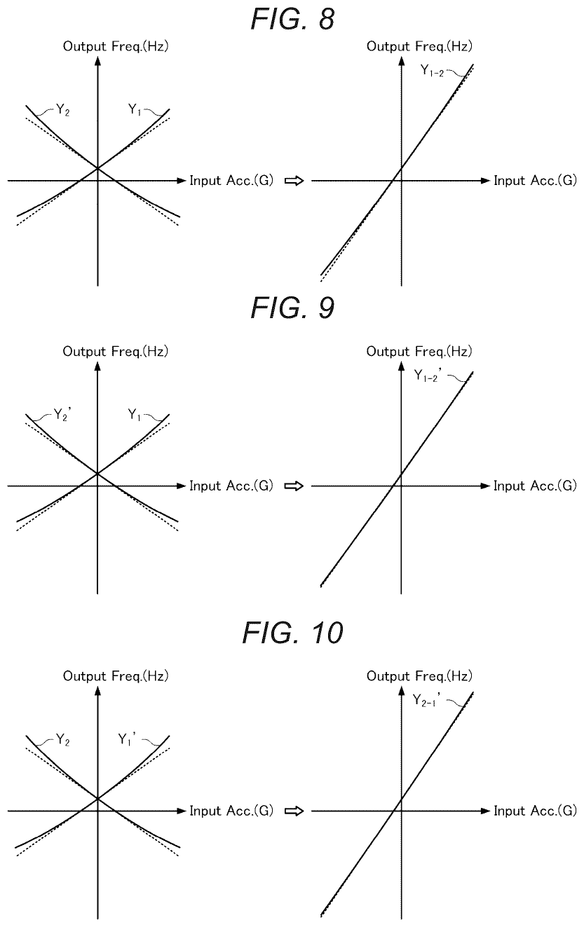

FIG. 8 illustrates an example of a relationship between the frequency Y₁, Y₂, Y₁₋₂ and an amplitude X₁ of acceleration. In FIG. 8, a broken line indicates an ideal straight line when quadratic terms in the formula (2), the formula (5), and the formula (8) are 0. As illustrated in FIG. 8, the frequency Y₁₋₂ is closer to the ideal straight line than the frequency Y₁, Y₂. Since a first-order coefficient (B₁+B₂) in the formula (8) indicates sensitivity of the frequency Y₁₋₂ with respect to the acceleration X and is B₁≈B₂, sensitivity of the frequency Y₁₋₂ is about twice that of sensitivity of the frequency Y₁, Y₂.

Similarly to deriving the vibration rectification error VRE₁ of the acceleration value in the +X direction represented by the formula (2) to the formula (5), formula (9) is obtained by deriving a vibration rectification error VRE₁₋₂ of the difference value between the acceleration value in the +X direction and the acceleration value in the −X direction from the formula (8).

$${VRE}_{1 - 2} = \frac{( {A}_{1} - {A}_{2} ) \cdot {{X}_{1}}^{2}}{2} \qquad ( 9 )$$

Since the difference between the second-order coefficients A₁, A₂ is very small, the vibration rectification error VRE₁₋₂ of the difference value between the acceleration value in the +X direction and the acceleration value in the −X direction represented by the formula (9) is smaller than the vibration rectification error VRE₁ of the acceleration value in the +X direction represented by formula the (5) or the vibration rectification error VRE₂ of the acceleration value in the −X direction represented by the formula (7).

Although not described, since the sensors 103 to 106 also have the same structure as the sensors 101, 102, a vibration rectification error of the difference value between the acceleration value in the +Y direction and the acceleration value in the −Y direction is smaller than a vibration rectification error of the acceleration value in the +Y direction and a vibration rectification error of the acceleration value in the −Y direction. Similarly, a vibration rectification error of the difference t value between the acceleration value in the +Z direction and the acceleration value in the −Z direction is smaller than a vibration rectification error of the acceleration value in the +Z direction and a vibration rectification error of the acceleration value in the −Z direction.

Thus, the vibration rectification error of the difference value between the acceleration value in the +X direction and the acceleration value in the −X direction calculated by the micro control unit 330 as the X-axis acceleration value is smaller than the vibration rectification error of the acceleration value in the +X direction and smaller than the vibration rectification error of the acceleration value in the −X direction. Similarly, the vibration rectification error of the difference value between the acceleration value in the +Y direction and the acceleration value in the −Y direction calculated by the micro control unit 330 as the Y-axis acceleration value is smaller than the vibration rectification error of the acceleration value in the +Y direction and smaller than the vibration rectification error of the acceleration value in the −Y direction. Similarly, the vibration rectification error of the difference value between the acceleration value in the +Z direction and the acceleration value in the −Z direction calculated by the micro control unit 330 as the Z-axis acceleration value is smaller than the vibration rectification error of the acceleration value in the +Z direction and smaller than the vibration rectification error of the acceleration value in the −Z direction.

In the first embodiment, the sensor 101 is an example of a “first sensor”, and the sensor 102 is an example of a “second sensor”. The sensor 103 is another example of the “first sensor”, and the sensor 104 is another example of the “second sensor”. The sensor 105 is another example of the “first sensor”, and the sensor 106 is another example of the “second sensor”. The detection axis D1 of the sensor 101 is an example of a “first detection axis”, and the detection axis D2 of the sensor 102 is an example of a “second detection axis”. The detection axis D3 of the sensor 103 is another example of the “first detection axis”, and the detection axis D4 of the sensor 104 is another example of the “second detection axis”. The detection axis D5 of the sensor 105 is another example of the “first detection axis”, and the detection axis D6 of the sensor 106 is another example of the “second detection axis”. The micro control unit 330 is an example of a “signal processing unit”. An acceleration value in the +X direction calculated by the micro control unit 330 is an example of a “first signal value”, and an acceleration value in the −X direction calculated by the micro control unit 330 is an example of a “second signal value”. An acceleration value in the +Y direction calculated by the micro control unit 330 is another example of the “first signal value”, and an acceleration value in the −Y direction calculated by the micro control unit 330 is another example of the “second signal value”. An acceleration value in the +Z direction calculated by the micro control unit 330 is another example of the “first signal value”, and an acceleration value in the −Z direction calculated by the micro control unit 330 is another example of the “second signal value”.

### 1-5. Functions and Effects

As described above, in the sensor device 1 according to the first embodiment, in the vibration rectification error correction circuit 2, due to an even-order component of the acceleration in each of the acceleration value in the +X direction, the acceleration value in the +Y direction, the acceleration value in the +Z direction, the acceleration value in the −X direction, the acceleration value in the −Y direction, and the acceleration value in the −Z direction calculated by the micro control unit 330, the vibration rectification error occurs in these acceleration values. Regarding this, in the vibration rectification error correction circuit 2, the micro control unit 330 calculates the difference value between the acceleration value in the +X direction and the acceleration value in the −X direction, the difference value between the acceleration value in the +Y direction and the acceleration value in the −Y direction, and the difference value between the acceleration value in the +Z direction and the acceleration value in the −Z direction, so that the even-order component of each of X-axis acceleration, Y-axis acceleration, and Z-axis acceleration is reduced. Therefore, according to the sensor device 1 in the first embodiment, in the vibration rectification error correction circuit 2, the vibration rectification error can be reduced with simple calculation by the micro control unit 330.

In the sensor device 1 according to the first embodiment, in the vibration rectification error correction circuit 2, since the detection axes of the sensors 101, 102 are opposite to each other, the detection axes of the sensors 103, 104 are opposite to each other, and the detection axes of the sensors 105, 106 are opposite to each other, positive and negative of values of first-order components of the acceleration in the acceleration value in the +X direction and the acceleration value in the −X direction calculated by the micro control unit 330 are opposite, positive and negative of values of first-order components of the acceleration in the acceleration value in the +Y direction and the acceleration value in the −Y direction are opposite, and positive and negative of values of first-order components of the acceleration in the acceleration value in the +Z direction and the acceleration value in the −Z direction are opposite. Therefore, according to the sensor device 1 in the first embodiment, in the vibration rectification error correction circuit 2, the micro control unit 330 calculates the difference value between the acceleration value in the +X direction and the acceleration value in the −X direction, the difference value between the acceleration value in the +Y direction and the acceleration value in the −Y direction, and the difference value between the acceleration value in the +Z direction and the acceleration value in the −Z direction, so that the value of the first-order component of each of the X-axis acceleration, the Y-axis acceleration, and the Z-axis acceleration increases, and thus detection sensitivity is improved.

In the sensor device 1 in the first embodiment, since each of the sensors 101 to 106 has a structure using the cantilever implemented by the joint portion 212 and the movable portion 214 and the vibration element 270 which is a quartz crystal vibration element having high frequency stability, a difference between the even-order components of the acceleration detected by the sensors 101, 102 decreases, a difference between the even-order components of the acceleration detected by the sensors 103, 104 decreases, and a difference between the even-order components of the acceleration detected by the sensors 105, 106 decreases. Therefore, according to the sensor device 1 in the first embodiment, in the vibration rectification error correction circuit 2, the micro control unit 330 calculates the difference value between the acceleration value in the +X direction and the acceleration value in the −X direction, the difference value between the acceleration value in the +Y direction and the acceleration value in the −Y direction, and the difference value between the acceleration value in the +Z direction and the acceleration value in the −Z direction, so that it is possible to reduce the vibration rectification error with simple calculation.

### 2. Second Embodiment

Hereinafter, in a sensor device according to the second embodiment, similar elements as those in the first embodiment are denoted by the same reference signs, description overlapping with the first embodiment is omitted or simplified, and contents different from those in the first embodiment will be mainly described.

Since the structure of the sensor device 1 according to the second embodiment is similar to that of FIGS. 1 to 6, illustration and description thereof will be omitted. A functional block diagram of the sensor device 1 according to the second embodiment is similar to that in FIG. 7, and thus illustration and description thereof are omitted. The sensor device 1 according to the second embodiment is different from the sensor device 1 according to the first embodiment in that the micro control unit 330 performs processing to reduce a vibration rectification error of an acceleration value.

A frequency Y₂′ obtained by multiplying the frequency Y₂ represented by the formula (6) above by any correction coefficient K is represented by formula (10).

$${{Y}_{2}}^{′} = K \cdot {Y}_{2} = K \cdot ( {Y}_{2 ( 0 G )} + {A}_{2} \cdot {( {X}_{1} \cdot cos ( ω t ) )}^{2} - {B}_{2} \cdot {X}_{1} \cdot cos ( ω t ) ) \qquad ( 10 )$$

From the formula (2) and the formula (10), the frequency Y₁₋₂′ obtained by subtracting the frequency Y₂′ from the frequency Y₁ is represented by formula (11).

$${{Y}_{1 - 2}}^{′} = {Y}_{1} - {Y}_{2}^{′} = {Y}_{1 ( 0 G )} - K \cdot {Y}_{2 ( 0 G )} + ( {A}_{1} - K \cdot {A}_{2} ) \cdot {( {X}_{1} \cdot cos ( ω t ) )}^{2} + ( {B}_{1} + K \cdot {B}_{2} ) \cdot {X}_{1} \cdot cos ( ω t ) \qquad ( 11 )$$

Here, when A₁>0 and A₂>0, and a condition of formula (12) is satisfied, a quadratic term of the frequency Y₁₋₂′ represented by the formula (11) is smaller than a quadratic term of the frequency Y₁₋₂ represented by the formula (8).

$$0 \leq \vert {A}_{1} - K \cdot {A}_{2} \vert < \vert {A}_{1} - {A}_{2} \vert \qquad ( 12 )$$

A range of the correction coefficient K satisfying the condition of the formula (12) is represented by formula (13).

$$\begin{matrix}1 < K \leq \frac{{A}_{1}}{{A}_{2}} & ( if {A}_{1} > {A}_{2} )\end{matrix} \qquad ( 13 )$$

$$\frac{{A}_{1}}{{A}_{2}} \leq K < 1 \qquad ( if {A}_{1} < {A}_{2} )$$

FIG. 9 illustrates an example of a relationship between the frequency Y₁, Y₂′, Y₁₋₂′ and the amplitude X₁ of acceleration. In FIG. 9, a broken line indicates an ideal straight line when quadratic terms in the formula (2), the formula (10), and the formula (11) are 0. In FIG. 9, A₁<A₂, and from the formula (13), by setting the correction coefficient K to a value in a range of A₁/A₂<K<1, the frequency Y₁₋₂′ becomes closer to the ideal straight line than the frequency Y₁₋₂ illustrated in FIG. 8.

From the formula (11), a vibration rectification error VRE₁₋₂′ of the difference value between the acceleration value in the +X direction and the acceleration value in the −X direction multiplied by the correction coefficient K is represented by formula (14).

$${{VRE}_{1 - 2}}^{′} = \frac{( {A}_{1} - K \cdot {A}_{2} ) \cdot {{X}_{1}}^{2}}{2} \qquad ( 14 )$$

In particular, when K=A₁/A₂, the vibration rectification error VRE₁₋₂′ can be set to 0 as illustrated in formula (15).

$${VRE}_{1 - 2}^{′} = \frac{( {A}_{1} - \frac{{A}_{1}}{{A}_{2}} \cdot {A}_{2} ) \cdot {X}_{1}^{2}}{2} = \frac{( 0 ) \cdot {X}_{1}^{2}}{2} = 0 \qquad ( 15 )$$

Therefore, in the second embodiment, the micro control unit 330 converts the count values CNT_XP and CNT_XN into the acceleration value in the +X direction and the acceleration value in the −X direction, respectively, and further calculates an acceleration value obtained by multiplying the acceleration value in the −X direction by the correction coefficient K. The correction coefficient K is determined to be a value in a range satisfying the formula (13), and is stored in the storage unit 340 in advance. That is, the correction coefficient K is set to a value based on a ratio A₁/A₂ of the second-order coefficient A₁ in the formula (2), which is an approximate expression of an output signal of the sensor 101 with the acceleration as a variable, to the second-order coefficient A₂ in the formula (6), which is an approximate expression of an output signal of the sensor 102 with the acceleration as a variable. The micro control unit 330 calculates a difference value between the acceleration value in the +X direction and the acceleration value in the −X direction multiplied by the correction coefficient K as the X-axis acceleration value.

Similarly, the micro control unit 330 calculates an acceleration value obtained by multiplying the acceleration value in the −Y direction by the correction coefficient K, and calculates a difference value between the acceleration value in the +Y direction and the acceleration value in the −Y direction multiplied by the correction coefficient K as the Y-axis acceleration value.

Similarly, the micro control unit calculates an acceleration value obtained by multiplying the acceleration value in the −Z direction by the correction coefficient K, and calculates a difference value between the acceleration value in the +Z direction and the acceleration value in the −Z direction multiplied by the correction coefficient K as the Z-axis acceleration value. The correction coefficients K used to calculate the X-axis acceleration value, the Y-axis acceleration value, and the Z-axis acceleration value may be different from each other.

The micro control unit 330 generates measurement data including the calculated X-axis acceleration value, Y-axis acceleration value, and Z-axis acceleration value, and transmits the measurement data to the external device 3 or writes the measurement data into the storage unit 340.

The first-order coefficient (B₁+K·B₂) in the formula (11) indicates sensitivity of the frequency Y₁₋₂′ with respect to the acceleration X. When K>1, the first-order coefficient (B₁+K·B₂) is larger than the first-order coefficient (B₁+B₂) which is the sensitivity of the frequency Y₁₋₂ illustrated in the formula (8). From the formula (13), when A₁>A₂, K>1, so B₁+K·B₂>B₁+B₂, and the sensitivity of the frequency Y₁₋₂′ increases, but when A₁<A₂, K<1, so B₁+K·B₂<B₁+B₂, and the sensitivity of the frequency Y₁₋₂′ decreases.

Here, a frequency Y₁′ obtained by multiplying the frequency Y₁ represented by the formula (2) above by any correction coefficient K is represented by formula (16).

$${Y}_{1}^{′} = K \cdot {Y}_{1} = K \cdot ( {Y}_{1 ( 0 G )} + {A}_{1} \cdot {( {X}_{1} \cdot cos ( ω t ) )}^{2} + {B}_{1} \cdot {X}_{1} \cdot cos ( ω t ) ) \qquad ( 16 )$$

From the formula (6) and the formula (16), a frequency Y₂₋₁′ obtained by subtracting the frequency Y₁′ from the frequency Y₂ is represented by formula (17).

$$\begin{matrix}{Y}_{2 - 1}^{′} = {Y}_{2} - {Y}_{1}^{′} \\ = {Y}_{2 ( 0 G )} - K \cdot {Y}_{1 ( 0 G )} + ( {A}_{2} - K \cdot {A}_{1} ) \cdot {( {X}_{1} \cdot cos ( ω t ) )}^{2} + \\ ( {B}_{2} + K \cdot {B}_{1} ) \cdot {X}_{1} \cdot cos ( ω t )\end{matrix} \qquad ( 17 )$$

Here, when A₁>0 and A₂>0, and a condition of formula (18) is satisfied, a quadratic term of the frequency Y₂₋₁′ represented by the formula (17) is smaller than the quadratic term of the frequency Y₁₋₂ represented by the formula (8).

$$0 \leq \vert {A}_{2} - K \cdot {A}_{1} \vert < \vert {A}_{1} - {A}_{2} \vert \qquad ( 18 )$$

A range of the correction coefficient satisfying the condition of the formula (18) is represented by formula (19).

$$\frac{{A}_{2}}{{A}_{1}} \leq K < 1 ( if {A}_{1} > {A}_{2} ) \qquad ( 19 )$$

$$1 < K \leq \frac{{A}_{2}}{{A}_{1}} ( if {A}_{1} < {A}_{2} )$$

From the formula (19), when A₁>A₂, K<1, so B₂+K·B₁<B₁+B₂, and the sensitivity of the frequency Y₂₋₁′ decreases, but when A₁<A₂, K>1, so B₂+K·B₁>B₁+B₂, and the sensitivity of the frequency Y₂₋₁′ increases.

FIG. 10 illustrates an example of a relationship between the frequency Y₁′, Y₂, Y₂₋₁′ and the amplitude X₁ of the acceleration. In FIG. 10, a broken line indicates an ideal straight line when quadratic terms in the formula (6), the formula (16), and the formula (17) are 0. In FIG. 10, A₁<A₂, and from the formula (19), by setting the correction coefficient K to a value in a range of 1<K≤A₁/A₂, the frequency Y₂₋₁′ becomes closer to the ideal straight line than the frequency Y₁₋₂ illustrated in FIG. 8. Further, the sensitivity of the frequency Y₂₋₁′ also increases.

Therefore, in order to increase the sensitivity, for the second-order coefficients A₁, A₂ of the sensors 101, 102, when A₁>A₂, the micro control unit 330 may calculate a difference value between the acceleration value in the +X direction and the acceleration value in the −X direction multiplied by the correction coefficient K larger than 1 as the X-axis acceleration value, and when A₁<A₂, the micro control unit 330 may calculate a difference value between the acceleration value in the +X direction multiplied by the correction coefficient K larger than 1 and the acceleration value in the −X direction as the X-axis acceleration value.

Similarly, for the second-order coefficients A₁, A₂ of the sensors 103, 104, when A₁>A₂, the micro control unit 330 may calculate a difference value between the acceleration value in the +Y direction and the acceleration value in the −Y direction multiplied by the correction coefficient K larger than 1 as the Y-axis acceleration value, and when A₁<A₂, the micro control unit 330 may calculate a difference value between the acceleration value in the +Y direction multiplied by the correction coefficient K larger than 1 and the acceleration value in the −Y direction as the Y-axis acceleration value. Similarly, for the second-order coefficients A₁, A₂ of the sensors 105, 106, when A₁>A₂, the micro control unit 330 may calculate a difference value between the acceleration value in the +Z direction and the acceleration value in the −Z direction multiplied by the correction coefficient K larger than 1 as the Z-axis acceleration value, and when A₁<A₂, the micro control unit 330 may calculate a difference value between the acceleration value in the +Z direction multiplied by the correction coefficient K larger than 1 and the acceleration value in the −Z direction as the Z-axis acceleration value.

Since the other configuration of the sensor device 1 according to the second embodiment is similar to that of the sensor device 1 according to the first embodiment, the description thereof will be omitted.

In the second embodiment, the sensor 101 is an example of the “first sensor”, and the sensor 102 is an example of the “second sensor”. The sensor 103 is another example of the “first sensor”, and the sensor 104 is another example of the “second sensor”. The sensor 105 is another example of the “first sensor”, and the sensor 106 is another example of the “second sensor”. The detection axis D1 of the sensor 101 is an example of the “first detection axis”, and the detection axis D2 of the sensor 102 is an example of the “second detection axis”. The detection axis D3 of the sensor 103 is another example of the “first detection axis”, and the detection axis D4 of the sensor 104 is another example of the “second detection axis”. The detection axis D5 of the sensor 105 is another example of the “first detection axis”, and the detection axis D6 of the sensor 106 is another example of the “second detection axis”. The micro control unit 330 is an example of the “signal processing unit”. An acceleration value in the +X direction calculated by the micro control unit 330 is an example of the “first signal value”, and a value obtained by multiplying the acceleration value in the −X direction calculated by the micro control unit 330 by the correction coefficient K is an example of the “second signal value”. An acceleration value in the +Y direction calculated by the micro control unit 330 is another example of the “first signal value”, and a value obtained by multiplying the acceleration value in the −Y direction calculated by the micro control unit 330 by the correction coefficient K is another example of the “second signal value”. An acceleration value in the +Z direction calculated by the micro control unit 330 is another example of the “first signal value”, and a value obtained by multiplying the acceleration value in the −Z direction calculated by the micro control unit 330 by the correction coefficient K is another example of the “second signal value”.

As described above, in the sensor device 1 according to the second embodiment, in the vibration rectification error correction circuit 2, the micro control unit 330 calculates the difference value between the acceleration value in the +X direction and the acceleration value in the −X direction multiplied by the correction coefficient K, the difference value between the acceleration value in the +Y direction and the acceleration value in the −Y direction multiplied by the correction coefficient K, and the difference value between the acceleration value in the +Z direction and the acceleration value in the −Z direction multiplied by the correction coefficient K, so that the even-order component of each of the X-axis acceleration, the Y-axis acceleration, and the Z-axis acceleration is further reduced. Therefore, according to the sensor device 1 in the second embodiment, in the vibration rectification error correction circuit 2, the vibration rectification error can be reduced with simple calculation by the micro control unit 330.

In particular, since a second-order component of the acceleration affects greatly the vibration rectification error, a second-order component of the three-axis acceleration is greatly reduced by setting values of the correction coefficients K to a value based on the ratio A₁/A₂ of the second-order coefficients A₁, A₂ corresponding to a coefficient of a second-order component of a physical quantity in each of the acceleration value in the +X direction and the acceleration value in the −X direction, a value based on the ratio A₁/A₂ of the second-order coefficients A₁, A₂ corresponding to a coefficient of a second-order component of a physical quantity in each of the acceleration value in the +Y direction and the acceleration value in the −Y direction, and a value based on the ratio A₁/A₂ of the second-order coefficients A₁, A₂ corresponding to a coefficient of a second-order component of a physical quantity in each of the acceleration value in the +Z direction and the acceleration value in the −Z direction, respectively. Therefore, according to the sensor device 1 in the second embodiment, in the vibration rectification error correction circuit 2, the vibration rectification error can be greatly reduced with simple calculation by the micro control unit 330.

In addition, according to the sensor device 1 in the second embodiment, the similar effects as those of the sensor device 1 in the first embodiment can be obtained.

### 3. Third Embodiment

Hereinafter, in a sensor device according to the third embodiment, similar elements as those in the first embodiment are denoted by the same reference signs, description overlapping with the first embodiment is omitted or simplified, and contents different from those in the first embodiment will be mainly described.

Since the structure of the sensor device 1 according to the third embodiment is similar to that of FIGS. 1 to 6, illustration and description thereof will be omitted. A functional block diagram of the sensor device 1 according to the third embodiment is similar to that in FIG. 7, and thus illustration and description thereof are omitted. The sensor device 1 according to the third embodiment is different from the sensor device 1 according to the first embodiment in that the micro control unit 330 performs processing to reduce a vibration rectification error of an acceleration value.

A frequency Y₂″ obtained by dividing the frequency Y₂ represented by the formula (6) by any correction coefficient K′ is represented by formula (20).

$${Y}_{2}^{″} = \frac{{Y}_{2}}{{K}^{′}} = \frac{{Y}_{2 ( 0 G )} + {A}_{2} \cdot {( {X}_{1} \cdot cos ( ω t ) )}^{2} - {B}_{2} \cdot {X}_{1} \cdot cos ( ω t )}{{K}^{′}} \qquad ( 20 )$$

From the formula (2) and the formula (20), a frequency Y₁₋₂″ obtained by subtracting the frequency Y₂″ from the frequency Y₁ is represented by formula (21).

$$\begin{matrix}{Y}_{1 - 2}^{″} = {Y}_{1} - {Y}_{2}^{″} \\ = {Y}_{1 ( 0 G )} - \frac{{Y}_{2 ( 0 G )}}{{K}^{′}} + ( {A}_{1} - \frac{{A}_{2}}{{K}^{′}} ) \cdot {( {X}_{1} \cdot cos ( ω t ) )}^{2} + \\ ( {B}_{1} + \frac{{B}_{2}}{{K}^{′}} ) \cdot {X}_{1} \cdot cos ( ω t )\end{matrix} \qquad ( 21 )$$

Here, when A₁>0 and A₂>0, and a condition of formula (22) is satisfied, a quadratic term of the frequency Y₁₋₂″ represented by the formula (21) is smaller than the quadratic term of the frequency Y₁₋₂ represented by the formula (8).

$$0 \leq \vert {A}_{1} - \frac{{A}_{2}}{{K}^{′}} \vert < \vert {A}_{1} - {A}_{2} \vert \qquad ( 22 )$$

A range of the correction coefficient K′ satisfying the condition of the formula (22) is represented by formula (23).

$$\frac{{A}_{2}}{{A}_{1}} \leq {K}^{′} < 1 ( if {A}_{1} > {A}_{2} ) \qquad ( 23 )$$

$$1 < {K}^{′} \leq \frac{{A}_{2}}{{A}_{1}} ( if {A}_{1} < {A}_{2} )$$

From the formula (21), a vibration rectification error VRE₁₋₂″ of the difference value between the acceleration value in the +X direction and the acceleration value in the −X direction is represented by formula (24).

$${VRE}_{1 - 2}^{″} = \frac{( {A}_{1} - \frac{{A}_{2}}{{K}^{′}} ) \cdot {X}_{1}^{2}}{2} \qquad ( 24 )$$

In particular, when K′=A₂/A₁, the vibration rectification error VRE₁₋₂″ can be set to 0 as illustrated in formula (25).

$${VRE}_{1 - 2}^{″} = \frac{( {A}_{1} - \frac{{A}_{1}}{{A}_{2}} \cdot {A}_{2} ) \cdot {X}_{1}^{2}}{2} = \frac{( 0 ) \cdot {X}_{1}^{2}}{2} = 0 \qquad ( 25 )$$

Therefore, in the third embodiment, the micro control unit 330 converts the count values CNT_XP and CNT_XN into the acceleration value in the +X direction and the acceleration value in the −X direction, respectively, and further calculates an acceleration value obtained by dividing the acceleration value in the −X direction by the correction coefficient K′. The correction coefficient K′ is determined to be a value in a range satisfying the formula (23), and is stored in the storage unit 340 in advance. That is, the correction coefficient K′ is set to a value based on the ratio A₂/A₁ of the second-order coefficient A₂ in the formula (6), which is an approximate expression of an output signal of the sensor 102 with the acceleration as a variable, to the second-order coefficient A₁ in the formula (2), which is an approximate expression of an output signal of the sensor 101 with the acceleration as a variable. The micro control unit 330 calculates a difference value between the acceleration value in the +X direction and the acceleration value in the −X direction divided by the correction coefficient K′ as the X-axis acceleration value.

Similarly, the micro control unit 330 calculates an acceleration value by dividing the acceleration value in the −Y direction by the correction coefficient K′, and calculates a difference value between the acceleration value in the +Y direction and the acceleration value in the −Y direction divided by the correction coefficient K′ as the Y-axis acceleration value. Similarly, the micro control unit 330 calculates an acceleration value by dividing the acceleration value in the −Z direction by the correction coefficient K′, and calculates a difference value between the acceleration value in the +Z direction and the acceleration value in the −Z direction divided by the correction coefficient K′ as the Z-axis acceleration value. The correction coefficients K′ used to calculate the X-axis acceleration value, the Y-axis acceleration value, and the Z-axis acceleration value may be different from each other.

The micro control unit 330 generates measurement data including the calculated X-axis acceleration value, Y-axis acceleration value, and Z-axis acceleration value, and transmits the measurement data to the external device 3 or writes the measurement data into the storage unit 340.

The first-order coefficient (B₁+B₂/K′) in the formula (21) indicates the sensitivity of the frequency Y₁₋₂″ with respect to the acceleration X. When K′<1, the first-order coefficient (B₁+B₂/K′) is larger than the first-order coefficient (B₁+B₂) which is the sensitivity of the frequency Y₁₋₂ illustrated in the formula (8). From the formula (23), when A₁>A₂, K′<1, so B₁+B₂/K′>B₁+B₂, and the sensitivity of the frequency Y₁₋₂″ increases, but when A₁<A₂, K′>1, so B₁+B₂/K′<B₁+B₂, and the sensitivity of the frequency Y₁₋₂″ decreases.

Here, a frequency Y₁″ obtained by dividing the frequency Y₁ represented by the formula (2) by any correction coefficient K′ is represented by formula (26).

$${Y}_{1}^{″} = \frac{{Y}_{1}}{{K}^{′}} = \frac{{Y}_{1 ( 0 G )} + {A}_{1} \cdot {( {X}_{1} \cdot cos ( ω t ) )}^{2} - {B}_{1} \cdot {X}_{1} \cdot cos ( ω t )}{{K}^{′}} \qquad ( 26 )$$

From the formula (6) and the formula (26), the frequency Y₂₋₁″ obtained by subtracting the frequency Y₁″ from the frequency Y₂ is represented by formula (27).

$$\begin{matrix}{Y}_{2 - 1}^{″} = {Y}_{2} - {Y}_{1}^{″} \\ = {Y}_{2 ( 0 G )} - \frac{{Y}_{1 ( 0 G )}}{{K}^{′}} + ( {A}_{2} - \frac{{A}_{1}}{{K}^{′}} ) \cdot {( {X}_{1} \cdot cos ( ω t ) )}^{2} + \\ ( {B}_{1} + \frac{{B}_{1}}{{K}^{′}} ) \cdot {X}_{1} \cdot cos ( ω t )\end{matrix} \qquad ( 27 )$$

Here, when A₁>0 and A₂>0, and a condition of formula (28) is satisfied, a quadratic term of the frequency Y₂₋₁″ represented by the formula (27) is smaller than the quadratic term of the frequency Y₁₋₂ represented by the formula (8).

$$0 \leq \vert {A}_{2} - \frac{{A}_{1}}{{K}^{′}} \vert < \vert {A}_{1} - {A}_{2} \vert \qquad ( 28 )$$

A range of the correction coefficient K′ satisfying the condition of the formula (28) is represented by formula (29).

$$1 < {K}^{′} \leq \frac{{A}_{1}}{{A}_{2}} ( if {A}_{1} > {A}_{2} ) \qquad ( 29 )$$

$$\frac{{A}_{1}}{{A}_{2}} \leq {K}^{′} < 1 ( if {A}_{1} < {A}_{2} )$$

From the formula (29), when A₁>A₂, K′>1, so B₂+B₁/K′<B₁+B₂, and the sensitivity of the frequency Y₂₋₁″ decreases, but when A₁<A₂, K′<1, so B₂+B₁/K′>B₁+B₂, and the sensitivity of the frequency Y₂₋₁″ increases.

Therefore, in order to increase the sensitivity, for the second-order coefficients A₁, A₂ of the sensors 101, 102, when A₁>A₂, the micro control unit 330 may calculate a difference value between the acceleration value in the +X direction and the acceleration value in the −X direction divided by the correction coefficient K′ smaller than 1 as the X-axis acceleration value, and when A₁<A₂, the micro control unit 330 may calculate a difference value between the acceleration value in the +X direction divided by the correction coefficient K′ smaller than 1 and the acceleration value in the −X direction as the X-axis acceleration value.

Similarly, for the second-order coefficients A₁, A₂ of the sensors 103, 104, when A₁>A₂, the micro control unit 330 may calculate a difference value between the acceleration value in the +Y direction and the acceleration value in the −Y direction divided by the correction coefficient K′ smaller than 1 as the Y-axis acceleration value, and when A₁<A₂, the micro control unit 330 may calculate a difference value between the acceleration value in the +Y direction divided by the correction coefficient K′ smaller than 1 and the acceleration value in the −Y direction as the Y-axis acceleration value. Similarly, for the second-order coefficients A₁, A₂ of the sensors 105, 106, when A₁>A₂, the micro control unit 330 may calculate a difference value between the acceleration value in the +Z direction and the acceleration value in the −Z direction divided by the correction coefficient K′ smaller than 1 as the Z-axis acceleration value, and when A₁<A₂, the micro control unit 330 may calculate a difference value between the acceleration value in the +Z direction divided by the correction coefficient K′ than smaller 1 and the acceleration value in the −Z direction as the Z-axis acceleration value.

Since the other configuration of the sensor device 1 according to the third embodiment is similar to that of the sensor device 1 according to the first embodiment, the description thereof will be omitted.

In the third embodiment, the sensor 101 is an example of the “first sensor”, and the sensor 102 is an example of the “second sensor”. The sensor 103 is another example of the “first sensor”, and the sensor 104 is another example of the “second sensor”. The sensor 105 is another example of the “first sensor”, and the sensor 106 is another example of the “second sensor”. The detection axis D1 of the sensor 101 is an example of a “first detection axis”, and the detection axis D2 of the sensor 102 is an example of a “second detection axis”. The detection axis D3 of the sensor 103 is another example of the “first detection axis”, and the detection axis D4 of the sensor 104 is another example of the “second detection axis”. The detection axis D5 of the sensor 105 is another example of the “first detection axis”, and the detection axis D6 of the sensor 106 is another example of the “second detection axis”. The micro control unit 330 is an example of the “signal processing unit”. An acceleration value in the +X direction calculated by the micro control unit 330 is an example of the “first signal value”, and a value obtained by dividing the acceleration value in the −X direction calculated by the micro control unit 330 by the correction coefficient K′ is an example of the “second signal value”. An acceleration value in the +Y direction calculated by the micro control unit 330 is another example of the “first signal value”, and a value obtained by dividing the acceleration value in the −Y direction calculated by the micro control unit 330 by the correction coefficient K′ is another example of the “second signal value”. An acceleration value in the +Z direction calculated by the micro control unit 330 is another example of the “first signal value”, and a value obtained by dividing the acceleration value in the −Z direction calculated by the micro control unit 330 by the correction coefficient K′ is another example of the “second signal value”.

As described above, in the sensor device 1 according to the third embodiment, in the vibration rectification error correction circuit 2, the micro control unit 330 calculates the difference value between the acceleration value in the +X direction and the acceleration value in the −X direction divided by the correction coefficient K′, the difference value between the acceleration value in the +Y direction and the acceleration value in the −Y direction divided by the correction coefficient K′, and the difference value between the acceleration value in the +Z direction and the acceleration value in the −Z direction divided by the correction coefficient K′, so that the even-order component of each of the X-axis acceleration, the Y-axis acceleration, and the Z-axis acceleration is further reduced. Therefore, according to the sensor device 1 in the third embodiment, in the vibration rectification error correction circuit 2, the vibration rectification error can be reduced with simple calculation by the micro control unit 330.

In particular, since the second-order component of the acceleration greatly affects the vibration rectification error, the second-order component of the three-axis acceleration is greatly reduced by setting values of the correction coefficients K′ to a value based on the ratio A₂/A₁ of the second-order coefficients A₂, A₁ corresponding to a coefficient of a second-order component of a physical quantity in each of the acceleration value in the −X direction and the acceleration value in the +X direction, a value based on the ratio A₂/A₁ of the second-order coefficients A₂, A corresponding to a coefficient of a second-order component of a physical quantity in each of the acceleration value in the −Y direction and the acceleration value in the +Y direction, and a value based on the ratio A₂/A₁ of the second-order coefficients A₂, A₁ corresponding to a coefficient of a second-order component of a physical quantity in each of the acceleration value in the −Z direction and the acceleration value in the +Z direction, respectively. Therefore, according to the sensor device 1 in the third embodiment, in the vibration rectification error correction circuit 2, the vibration rectification error can be greatly reduced with simple calculation by the micro control unit 330.

In addition, according to the sensor device 1 in the third embodiment, the similar effects as those of the sensor device 1 in the first embodiment can be obtained.

### 4. Modification

The present disclosure is not limited to the embodiments, and various modified implementations can be made within the scope of the gist of the present disclosure.

For example, in each of the embodiments described above, the sensor device 1 includes the six sensors 101 to 106, but the number of sensors in the sensor device 1 may be five or less, or may be seven or more.

In each of the embodiments described above, the sensor device 1 including the acceleration sensor is exemplified, but the sensor device 1 may include a sensor such as an angular velocity sensor, a pressure sensor, or an optical sensor. The sensor device 1 may include two or more types of sensors among various sensors such as an acceleration sensor, an angular velocity sensor, a pressure sensor, and an optical sensor.

In each of the embodiments described above, an element implemented using quartz crystal is exemplified as the sensor element 200 in each of the sensors 101 to 106, but the sensor element 200 may be implemented using a piezoelectric element other than the quartz crystal, or may be a capacitance-type MEMS element. MEMS is an abbreviation for Micro Electro Mechanical Systems.

The embodiments and the modifications described above are illustrative only, and the present disclosure is not limited thereto. For example, it is possible to appropriately combine the embodiments and the modifications with each other.

The present disclosure includes substantially the same configurations as the configurations described in the embodiment, such as configurations having the same functions, methods, and results, or configurations having the same objects and advantages. Further, the present disclosure includes a configuration in which a non-essential portion of the configuration described in the embodiments is replaced. Further, the present disclosure includes configurations that exert the same functions and effects or configurations that can achieve the same objects as those of the configurations described in the embodiment. Further, the present disclosure includes a configuration obtained by adding a known technique to the configuration described in the embodiments.

The following can be derived from the above-described embodiment and modification.

A vibration rectification error correction circuit according to an aspect includes a signal processing unit configured to calculate a difference value between a first signal value based on a physical quantity detected by a first sensor having a first detection axis and a second signal value based on the physical quantity detected by a second sensor having a second detection axis in an opposite direction to the first detection axis, and a vibration rectification error of the difference value is smaller than a vibration rectification error of the first signal value and smaller than a vibration rectification error of the second signal value.

In the vibration rectification error correction circuit, although the vibration rectification error occurs in the first signal value and the second signal value due to an even-order component of the physical quantity in each of the first signal value and the second signal value, the even-order component of the physical quantity is reduced by calculating a difference value between the first signal value and the second signal value. Therefore, according to the vibration rectification error correction circuit, it is possible to reduce the vibration rectification error with simple calculation.

In the vibration rectification error correction circuit, since the detection axes of the first sensor and the second sensor are opposite to each other, positive and negative of values of first-order components of the physical quantities in the first signal value and the second signal value are opposite to each other. Therefore, according to the vibration rectification error correction circuit, since the value of the first-order component of the physical quantity increases by calculating the difference value between the first signal value and the second signal value, detection sensitivity is improved.

In the vibration rectification error correction circuit according to the aspect, the second signal value may be a value obtained by multiplying a signal value based on the physical quantity detected by the second sensor by a correction coefficient.

In the vibration rectification error correction circuit, the even-order component of the physical quantity is further reduced by calculating the difference value between the first signal value and the second signal value multiplied by the correction coefficient. Therefore, according to the vibration rectification error correction circuit, it is possible to further reduce the vibration rectification error with simple calculation.

In the vibration rectification error correction circuit according to the aspect, a value of the correction coefficient may be a value based on a ratio of a second-order coefficient of an approximate expression of an output signal of the first sensor with the physical quantity as a variable to a second-order coefficient of an approximate expression of an output signal of the second sensor with the physical quantity as the variable.

In the vibration rectification error correction circuit, since a second-order component of the physical quantity greatly affects the vibration rectification error, the second-order component of the physical quantity is greatly reduced by setting a value of the correction coefficient to a value based on a ratio of second-order coefficients corresponding to coefficients of the second-order components of the physical quantities in the first signal value and the second signal value. Therefore, according to the vibration rectification error correction circuit, it is possible to greatly reduce the vibration rectification error with simple calculation.

In the vibration rectification error correction circuit according to the aspect, the second signal value may be a value obtained by dividing a signal value based on the physical quantity detected by the second sensor by a correction coefficient.

In the vibration rectification error correction circuit, the even-order component of the physical quantity is further reduced by calculating the difference value between the first signal value and the second signal value divided by the correction coefficient. Therefore, according to the vibration rectification error correction circuit, it is possible to further reduce the vibration rectification error with simple calculation.

In the vibration rectification error correction circuit according to the aspect, a value of the correction coefficient may be a value based on a ratio of a second-order coefficient of an approximate expression of an output signal of the second sensor with the physical quantity as a variable to a second-order coefficient of an approximate expression of an output signal of the first sensor with the physical quantity as the variable.

In the vibration rectification error correction circuit, since a second-order component of the physical quantity greatly affects the vibration rectification error, the second-order component of the physical quantity is greatly reduced by setting the value of the correction coefficient to a value based on a ratio of second-order coefficients corresponding to coefficients of the second-order components of the physical quantities in the second signal value and the first signal value. Therefore, according to the vibration rectification error correction circuit, it is possible to greatly reduce the vibration rectification error with simple calculation.

In the vibration rectification error correction circuit according to the aspect, the physical quantity may be acceleration, and each of the first sensor and the second sensor may include a cantilever configured to be deformed by application of the physical quantity, and a quartz crystal vibration element whose vibration frequency changes due to stress caused by deformation of the cantilever.

According to the vibration rectification error correction circuit, since each of the first sensor and the second sensor detects the acceleration by a structure using the cantilever and the quartz crystal vibration element having high frequency stability, a difference between an even-order component of the acceleration detected by the first sensor and an even-order component of the acceleration detected by the second sensor is reduced. Therefore, according to the vibration rectification error correction circuit, it is possible to reduce the vibration rectification error with simple calculation by calculating the difference value between the first signal value and the second signal value.

The sensor device according to an aspect includes: the vibration rectification error correction circuit according to the aspect; the first sensor; and the second sensor.

According to the sensor device, by including the vibration rectification error correction circuit and the first sensor and the second sensor whose detection axes are opposite to each other, it is possible to generate measurement data in which the vibration rectification error is reduced with simple calculation.

What is claimed is:

1. A vibration rectification error correction circuit comprising:
a signal processing unit configured to calculate a difference value between a first signal value based on a physical quantity detected by a first sensor having a first detection axis and a second signal value based on the physical quantity detected by a second sensor having a second detection axis in an opposite direction to the first detection axis, wherein
a vibration rectification error of the difference value is smaller than a vibration rectification error of the first signal value and smaller than a vibration rectification error of the second signal value.

2. The vibration rectification error correction circuit according to claim 1, wherein
the second signal value is a value obtained by multiplying a signal value based on the physical quantity detected by the second sensor by a correction coefficient.

3. The vibration rectification error correction circuit according to claim 2, wherein
a value of the correction coefficient is a value based on a ratio of a second-order coefficient of an approximate expression of an output signal of the first sensor with the physical quantity as a variable to a second-order coefficient of an approximate expression of an output signal of the second sensor with the physical quantity as the variable.

4. The vibration rectification error correction circuit according to claim 1, wherein
the second signal value is a value obtained by dividing a signal value based on the physical quantity detected by the second sensor by a correction coefficient.

5. The vibration rectification error correction circuit according to claim 4, wherein
a value of the correction coefficient is a value based on a ratio of a second-order coefficient of an approximate expression of an output signal of the second sensor with the physical quantity as a variable to a second-order coefficient of an approximate expression of an output signal of the first sensor with the physical quantity as the variable.

6. The vibration rectification correction circuit according to claim 1, wherein
the physical quantity is acceleration, and
each of the first sensor and the second sensor includes
a cantilever configured to be deformed by application of the physical quantity, and
a quartz crystal vibration element whose vibration frequency changes due to stress caused by deformation of the cantilever.

7. A sensor device comprising:
the vibration rectification error correction circuit according to claim 1;
the first sensor; and
the second sensor.
